(19) United States
(12) Patent Application Publication
(10) Pub. No.: US 2007/0149040 A1
(43) Pub. Date: Jun. 28, 2007

(54) ELECTRICAL/PNEUMATIC CABLE LOCKOUT DEVICE

(75) Inventors: Derek Forsythe, Dryden, MI (US); Brian Miller, Imlay City, MI (US)

Correspondence Address: DOBRUSIN & THENNISCH PC, 29 W LAWRENCE ST, SUITE 210, PONTIAC, MI, 48342, US

(73) Assignee: L&L Products, Inc.

(21) Appl. No.: 11/612,913

(22) Filed: Dec. 19, 2006

Related U.S. Application Data
(60) Provisional application No. 60/753,973, filed on Dec. 23, 2005.

(51) Int. Cl. H01R 13/00

(52) U.S. Cl. 439/487

(57) ABSTRACT

The present invention is predicated upon the provision of systems, methods and devices for securing electrical, pneumatic, hydraulic and other connectors and associated conduits used for the operation of manufacturing machines (e.g., injection molding machines), mechanical or electrical devices, or the like, thereby rendering the same substantially safe for maintenance, repair or otherwise.

### CLAIM OF PRIORITY

The present invention claims priority to U.S. Provisional Patent Application No. 60/753,973, filed on Dec. 23, 2005, the contents of which are entirely incorporated herein for all purposes.

### FIELD OF THE INVENTION

The present invention is predicated upon the provision of a systems methods and devices for securing from use electrical, pneumatic, hydraulic and other connectors (and associated conduits) used for the operation of manufacturing machines (e.g., injection molding machines), mechanical or electrical devices, or the like, thereby rendering the same substantially safe for maintenance, repair or otherwise.

### BACKGROUND OF THE INVENTION

Machining facilities typically include machines for forming various parts for devices. Such machines may include drills, presses, lathes, saws, or otherwise for forming such parts. From time to time, it becomes necessary to repair, replace or clean components or otherwise service these machines to insure accurate and reliable performance. Often, this requires the disassembly of components to gain access to internal component of the devices.

Prior to performing work on these components, the technician renders the machine inoperable by disconnecting any power source thereto. This may include electrical power, hydraulic power, pneumatic power or otherwise. As an added safety measure, the technician is require to periodically monitor the surrounding premises to insure that these power conduits are not accidentally connected to a power source. However, this may be difficult during complex disassembly of the components forming the machine.

In view of the foregoing, there is a need for an improved methods, systems and devices for rendering such machines inoperable during certain time periods.

### SUMMARY OF THE INVENTION

The present invention provides systems, methods and devices for securing conduits used for supplying electricity, hydraulics, pneumatics or other power to machine components.

In one aspect, the present invention provides a securing device for one or more connectors. The device includes a main body forming a portion of an enclosure, which defines at least one opening extending through a side wall of the main body. The device also includes a cover for forming a portion of the enclosure and defining at least a portion of the at least one opening. Each of the at least one openings are configured for receiving one or more power connectors of a machine when the cover is in an open position and at least a portion of the one or more power connectors are secured within the enclosure when the cover is in a closed position.

In another aspect, the present invention provides an enclosure for the storage and securing of one or more connectors of a machine. The enclosure includes a substantially flat base portion having one or more mounting features for mounting the enclosure to a building. The enclosure also includes one or more integrally formed sidewalls extending generally perpendicular from the base portion at a first end. The one or more sidewalls include one or more slotted portions extending from a second end of the one or more sidewalls at an end opposite the base portion. The enclosure further includes a cover pivotally mounted to the one or more sidewalls. The cover has a corresponding shape to the second end of the one or more sidewalls and is adapted to engage the one or more sidewalls at the second end to form an enclosure. Preferably, in one configuration the enclosure further includes an engagement feature for releasably attaching the cover to the one or more sidewalls, wherein upon attachment the one or more slotted portions form one or more openings having a diameter less than the diameter of a portion of a connector for a machine.

In yet another aspect, the present invention provides a method of securing one or more power conduits of a machine. The method including the steps of: a) providing an enclosure including: i) one or more openings defined through sidewalls of the enclosure, ii) a cover adapted to releasably engage the sidewalls of the enclosure to form a portion of the enclosure and one or more openings; b) attaching the enclosure to a structural component located proximate to a machine having one or more power conduits; c) placing a portion of the power conduits within an opening such that a portion of the conduit having a larger diameter than the opening is located within the enclosure; and d) moving the cover of the enclosure into a closed position to engage the cover with the one or more sidewalls and to secure at least a portion of the conduits within the enclosure.

It should be appreciated that the above referenced aspects and examples are non-limiting as other exists with the present invention, as shown and described herein. For example, any of the above mentioned aspects or features of the invention may be combined to form other unique configurations, as described herein, demonstrated in the drawings, or otherwise.

### BRIEF DESCRIPTION OF THE DRAWINGS

FIG. 1 illustrates a front perspective view of an enclosure according to one aspect of the present invention.

FIG. 2 illustrates a rear perspective view of the enclosure shown in FIG. 1.

FIGS. 3 and 4 illustrate side perspective views of the enclosure shown in FIG. 1.

FIGS. 5a and 5b illustrates perspective views of the enclosure shown in FIG. 1 in an open position with connectors and/or conduits extending at least partially therein.

FIG. 6 illustrates a perspective view of the enclosure shown in FIG. 1 in a closed position with connectors and/or conduits extending at least partially therein.

FIG. 7 illustrates a cross sectional view of the enclosure shown in FIG. 1.

### DETAILED DESCRIPTION

In general, the present invention provides an enclosure for the storage and securing of one or more connectors for one or more devices. The enclosure is configured for permanent or temporary attachment to a permanent or semi-permanent structure, such as a vertical wall of a building, or otherwise. The enclosure also provides a cover adapted for movement between an open and closed position for receiving and securing portions of the one or more devices (e.g., cords or connectors). The enclosure is further configured for providing one or more openings for allowing at least a portion of the one or more connectors to extend into and/or through the enclosure while in a closed position. However, preferably the one or more openings include a diameter smaller than at least a portion of the connectors stored therein for preventing the connectors from exiting the enclosure when the cover is in a closed position.

In one application, the enclosure is adapted for securing connectors used for the operation of machine devices. In this application, the enclosure may specifically be adapted for securing the end portion (e.g., plug portion) of electrical connectors, pneumatic connectors, hydraulic connectors or otherwise, for preventing a power supply from reaching the machine thereby rendering the machine temporarily inoperable. This is particularly advantageous during maintenance or repair of the device to insure that the device is not electrically, pneumatically, hydraulically or otherwise activated. Accordingly, the enclosure may act as a safety locking device within a machining facility, the like or otherwise.

In one preferred embodiment, the enclosure is adapted to be attached or integrally formed with a manufacturing machine or a structure associated with the machine such as fencing or partitions about the machine. Exemplary manufacturing machines can include, without limitations, molding machines (e.g., injection or blow molding machines), extruders, robotic machines, drills, presses, lathes, saws combinations thereof, or otherwise.

The following is a description of certain components that may be used to form the device of the present invention. It should be appreciated that more or less components may be used. It should also be appreciated that one or more of the components may be integrally formed together or separated.

Main Body

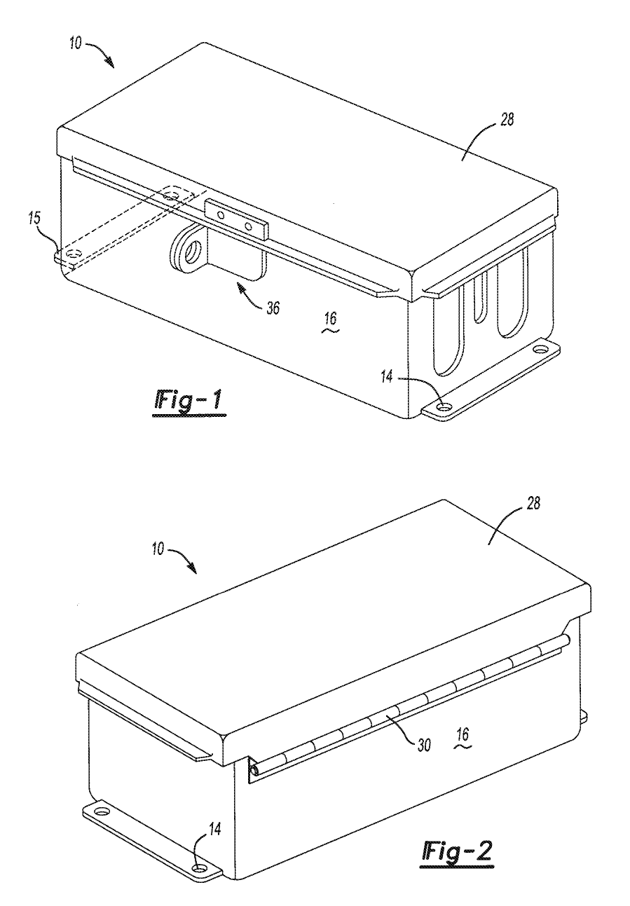

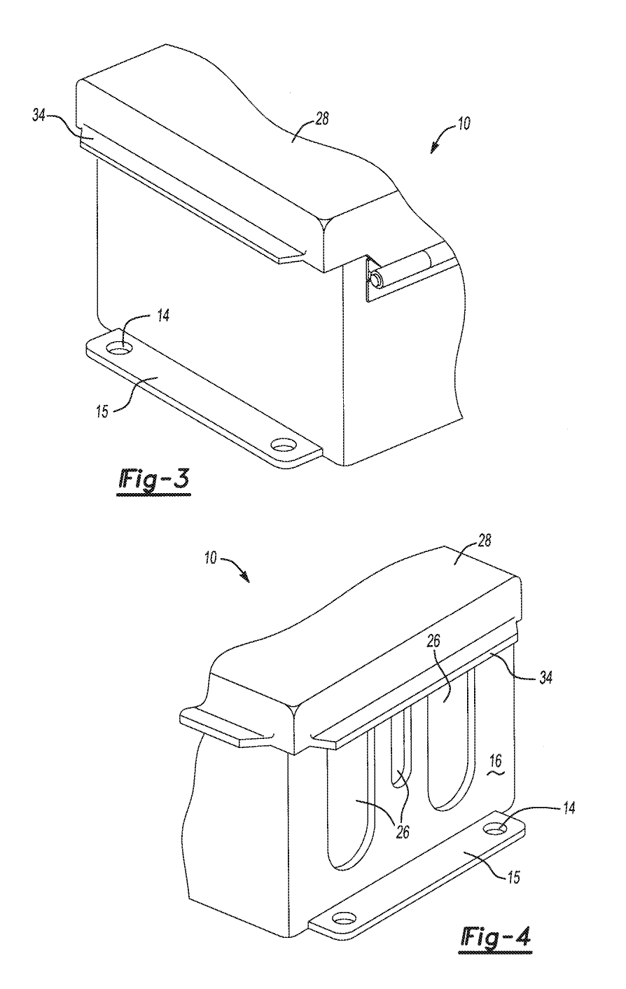

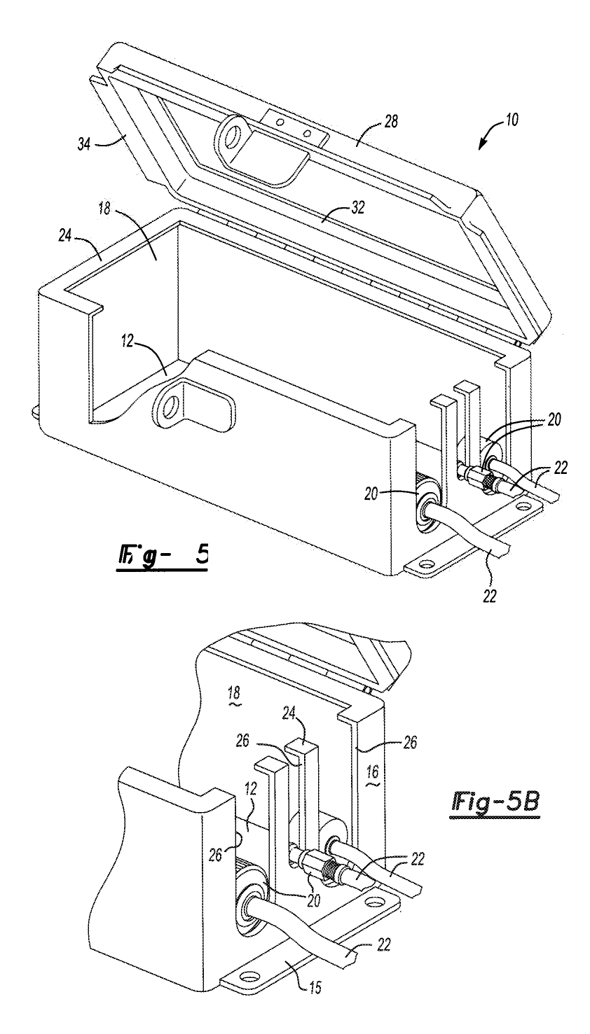

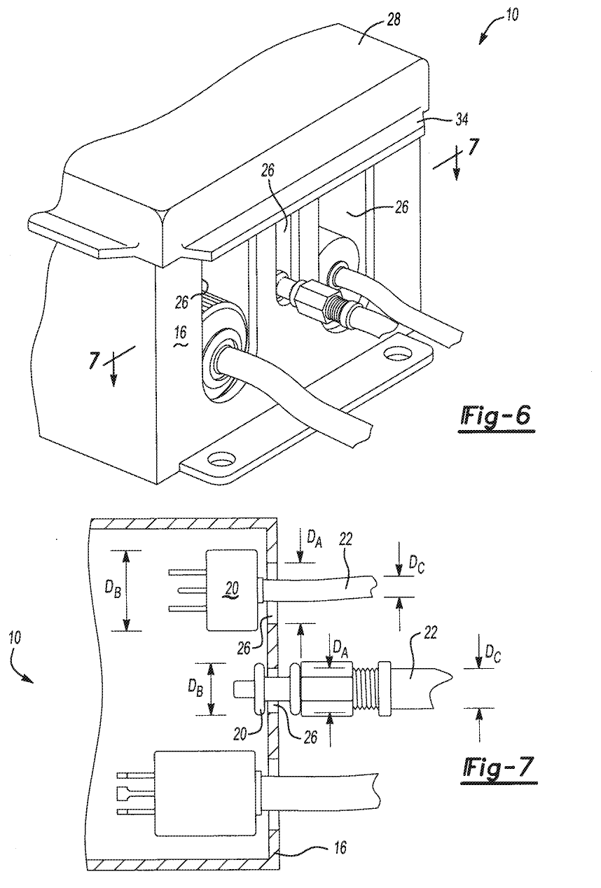

Referring to FIGS. 1-7, one exemplary embodiment of the enclosure 10 of the present invention is shown. The enclosure may include a main body forming at least a portion of the enclosure. The main body includes a substantially flat base portion 12 adapted for placement and attachment to a corresponding structure such as a wall portion, frame member or otherwise. The base portion may be symmetrical or non-symmetrical in shape. For example, as shown in the drawings, the base portion may be rectangular. However, it should be appreciated that other symmetrical shapes are contemplated including circular, oval, triangular, pentagonal, etc. Also, it is contemplated that the base portion may be shaped to correspond to a corresponding structure thereof, such as a poll, beam, or otherwise.

Preferably, the base portion includes one or more attachment features 14 for mounting the base portion, and optionally the entire enclosure, to a corresponding structure. In one configuration, the one or more attachment features comprise openings formed through the base portion for receiving one or more fasteners, particularly machine fasteners such as screws, nails, rivets, snap fittings or other fasteners adapted for engagement a corresponding attachment feature. Of course other fastening systems are contemplated including wire, tape, adhesives, restrictive placement, or otherwise.

As shown, it should be appreciated that the attachment features may be located internal to the enclosure to prevent removal of the enclosure when in a closed position. However, the attachment feature may also be externally located from the enclosure such as through a flange 15 or otherwise. In such a configuration, the fastener may be adapted for substantial permanent mounting such that the fastener is not easily removable.

The main body also includes one or more sidewalls 16 extending substantially about the perimeter of the base portion to form at least a portion of a cavity 18. The cavity formed in the enclosure is configured for receiving connectors 20 which are in communications with a machine device, as previously discussed, via a conduit 22. The sidewalls may extend substantially perpendicular, with respect to the base portion, at a first end and maybe integrally formed with the base portion. Optionally, the second end of the sidewalls includes a mating surface, such as an inwardly extending lip 24, or the like, which is preferably substantially parallel to the base portion, for joining with a corresponding member. It should also be appreciated that, as with the base portion, the lip may be integrally formed with the sidewalls.

The sidewalls are configured with one or more openings for allowing one or more connectors and/or conduits to extend through the enclosure. Preferably, the one or more openings (e.g., cavities, through-holes, or the like) include a diameter which sized to prevent removal of the connectors when the enclosure is in a closed position. For example, the one or more openings formed by the enclosure may include a diameter ‘D_{A}’ that is sufficiently less than the diameter ‘D_{B}’ of at least a portion of the connectors located within a cavity to prevent removal of the connector. As such, the connectors are prevented from moving through (or at least exiting) the one or more openings, thereby providing the ability for the connectors to be secured within the enclosure. Also, the one or more openings formed in the sidewalls may include a diameter ‘D_{A}’ greater than the diameter ‘D_{C}’ of a corresponding conduit connected to the connectors or another portion of the connector itself.

As shown in the drawings, in one configuration, the one or more openings for receiving the connectors comprise slots 26, or the like, extending through the sidewalls and any lip formed therewith. In this configuration, the slots include a diameter that is less than the diameter of at least a portion of a connector or plug portion but equal or greater than the diameter of a conduit connected thereto. In another configuration, the slots may be configured with a diameter that is less than the greatest diameter of a connector and greater than the smallest diameter of the connector. Accordingly, the connector may extend only partially within the cavity formed by the enclosure. Other configurations are contemplated.

It should be appreciated that the side walls include one, two, three, four, five, six, seven, eight, nine, or more openings for receiving the devices. Similarly, it should be appreciated that the enclosure may include one or more openings formed on one, two, three, four, five or more sides of the enclosures. Also, it is contemplated that each opening may be configured to receive and secure one, two, three or more connectors. Other configurations are available, as well.

Cover

The enclosure further includes a cover 28 for enclosing the cavity 18 formed by the main body (e.g., sidewalls 16 and the base portion 12). Preferably, the cover is movably joined, via a hinge 30 or otherwise, with the base potion, sidewalls or both to provide motion between an open and closed position. This also provides alignment between the cover and sidewalls. In this configuration, the connectors would be removable during an open position, while they are secured to the enclosure in a closed position.

Preferably, the enclosure is configured to matingly join with the second end of the sidewalls. Accordingly, it is contemplated that the cover has a corresponding shape to the sidewalls and more preferably, is shaped to matingly engage with the sidewalls. In one preferred configuration, the cover includes a mating surface adapted to engage the lip extending from the sidewalls. Optionally, one or more seals, such as a gasket 32, may be located between the cover portion and the lip for forming a seal, vibration dampening, sound dampening, or otherwise improve the overall function, sealing and feel of the enclosure.

As previously mentioned, the sidewalls form one or more openings for allowing connectors and/or conduits to pass therethrough. In view of the slots formed in the sidewalls, it should be appreciated that the cover may form a portion of the one or more openings. In doing so, it is contemplated that the cover may include one or more flange 34, or other feature, for further defining the one or more openings. Also, it is contemplated that cover may form a portion of the connectors.

Engagement Feature

Optionally, the box may include an engagement feature 36 for maintaining the position of the cover with respect to the sidewalls. Accordingly, it is contemplated that the engagement feature may be configured to releasably lock the enclosure in a closed position.

In one configuration, as shown in the drawings, the cover and sidewalls include corresponding engagement features adapted to matingly engage and more particularly align to form an opening for receiving a locking member, such as a pad lock or otherwise.

Preferably, although not required, the container will include a single locking device such that an individual can lock each of the connectors into the enclosure and that individual can keep an unlocking mechanism (e.g., key or combination) with them while he or she performs maintenance on the machine thus assuring that none of the connectors are removed from the container during such maintenance.

Enclosure

The enclosure can form numerous shapes including a box or cube like structure, as shown in the drawings. However, other shapes are available to form the enclosure of the present invention.

The enclosure may be formed of numerous materials available to form a rigid structure. The components forming the enclosure may be formed of similar or dissimilar materials. Preferably, the material is suitable in strength to prevent access to the contents of the enclosure without substantial effort. Available materials include metal, plastic, rubber, combinations thereof, or otherwise. However, a preferred material comprises metal or otherwise includes metal (e.g., a single metal or alloy).

The enclosure may include various colors designed to provide improved indication of presence and/or purpose of the enclosure. For example, it is contemplated that the box may comprise a bright yellow, orange or other common color used in an industrial setting. Also, it is contemplated that the enclosure may include other indications of presence and/or purpose including designs, text or otherwise.

Application

The enclosure may be use in various industries including manufacturing plants wherein machines require connectors for the use of electricity, pneumatics, hydraulics, or other sources of power for operation. In such applications, the enclosure of the present invention may be placed on an adjacent wall to the machine, and preferably within the reach of any conduit line, for providing such power.

In utilizing the enclosure, the enclosure is mounted to a vertical or other structure adjacent to an industrial machine such that the power connections for the machine are within reach of the enclosure. The enclosure is then placed in an open position and the connectors (or at least a portion of the connectors) of the machine are placed within the cavity of the enclosure. The conduit connecting the connector to the machine is then placed or positioned within the openings formed in the sidewalls. Alternatively, a portion of the connector may be placed or positioned within the opening. The cover of the enclosure is moved into a closed position and preferably latched or otherwise engages the sidewalls of the enclosure. With the opening of the sidewalls having a diameter smaller than at least a portion of the connectors, it should be appreciated that the connectors are prevented from exiting the enclosure when in a closed position. Optionally, the enclosure may be locked in a closed position through a releasable locking feature, as described herein or otherwise.

With all of the power connectors locked within the enclosure of the present invention, the machine having the connectors is preferably rendered substantially non-functional. In this state, the machine can be repaired, maintenanced or otherwise, without concern of unexpected movement of the components as a result of an application of force through the connectors. Upon completion of maintenance or repair of the machine, the enclosure is unlocked and the power connectors removed and used as desired.

Optionally, the enclosure may be adapted for receiving connectors for more than one machine. Accordingly, it is contemplated that the enclosure may be placed within reach of several machines.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A securing device for one or more connectors, the device including:
a main body forming a portion of an enclosure, the main body defining at least one opening extending through a side wall of the main body; and
a cover for forming a portion of the enclosure and defining at least a portion of the at least one opening;
wherein each of the at least one opening are configured for receiving one or more power connectors of a machine when the cover is in an open position and wherein at least a portion of the one or more power connectors are secured within the enclosure when the cover is in a closed position.

2. The device of claim 1, wherein the at least one opening has a diameter that is:
i) equal or greater than at least one portion of the one or more power connectors; and
ii) smaller than at least one other portion of the one or more power connectors.

3. The device of claim 2, wherein the opening is formed by a groove or slot extending along a side wall portion of the main body between a first end and a second end, the groove or slot having a substantially continuous diameter.

4. The device of claim 1, wherein the main body includes a mounting feature for attachment to a structural component proximate to the machine.

5. The device of claim 1, wherein the cover is hingedly attached to the main body for rotating between the open and closed position.

6. The device of claim 5, further comprising an engagement feature for releasably engaging the cover to the main body when the cover is in a closed position.

7. The device of claim 6, wherein the main body, cover or both include a mating feature for matingly engaging the other of said main body or cover.

8. The device of claim 7, further comprising a seal located between the main body and cover.

9. The device of claim 5, further compromising a releasable lock for preventing disengagement of the of the engagement feature.

10. The device of claim 1, wherein the main body defines two openings extending through a side wall of the main body for receiving and securing two power connectors of the machine.

11. The device of claim 1, wherein the main body defines three or more openings extending through a side wall of the main body for receiving three or more power connectors of the machine.

12. The device of claim 1, wherein the power connector of the machine comprises an electrical connector, a hydraulic connector, a pneumatic connector or combinations thereof.

13. The device of claim 1, wherein the main body comprises a substantially flat base portion having one or more mounting feature for mounting the main body to a structure and wherein the main body further includes one or more sidewalls extending generally perpendicular from the base portion and form the one or more openings.

14. The device of claim 1, wherein the device includes color, markings, insignia or combinations thereof for creating attention to the device.

15. An enclosure for the storage and securing of one or more connectors of a machine, the enclosure includes:
a substantially flat base portion having one or more mounting features for mounting the enclosure to a building;
one or more integrally formed sidewalls extending generally perpendicular from the base portion at a first end, the one or more sidewalls including one or more slotted portions extending from a second end of the one or more sidewalls at an end opposite the base portion;
a cover pivotally mounted to the one or more sidewalls, the cover having a corresponding shape to the second end of the one or more sidewalls and being adapted to engage the one or more sidewalls at the second end to form an enclosure; and
an engagement feature for releasably attaching the cover to the one or more sidewalls, wherein upon attachment the one or more slotted portions form one or more openings having a diameter less than the diameter of a portion of a connector for a machine.

16. A method of securing one or more power conduits of a machine, the method including the steps of:
a) providing an enclosure including:
i) one or more openings defined through sidewalls of the enclosure,
ii) a cover adapted to releasably engage the sidewalls of the enclosure to form a portion of the enclosure and one or more openings;
b) attaching the enclosure to a structural component located proximate to a machine having one or more power conduits;
c) placing a portion of the power conduits within an opening such that a portion of the conduit having a larger diameter than the opening is located within the enclosure; and
d) moving the cover of the enclosure into a closed position to engage the cover with the one or more sidewalls and to secure at least a portion of the conduits within the enclosure.

17. The method of claim 16, further comprising the step of releasably locking the cover to the one or more sidewalls.

18. The method of claim 16, further comprising the step of placing color, markings, insignia or combinations thereof onto the enclosure for creating attention thereto.

19. The method of claim 16, wherein the cover is hingedly attached to the sidewalls.

20. The method of claim 16, further comprising a base portion attached to the sidewalls at an end opposite the cover, wherein the enclosure is substantially formed by the combination of the sidewalls, base portion and cover.
